(19) United States
(12) Patent Application Publication
(10) Pub. No.: US 2014/0114593 A1
(43) Pub. Date: Apr. 24, 2014

(54) APPARATUS AND METHOD FOR CALCULATING ELECTRICAL CHARGE QUANTITY OR ELECTRICAL DISCHARGE QUANTITY FOR BATTERY UNIT ACCORDING TO CALIBRATION PARAMETER USED FOR ADJUSTING TIME INTERVAL OF ELECTRICAL CHARGE/DISCHARGE CALCULATION, AND METHOD FOR CALIBRATING INTEGRAL TIME INTERVAL

(71) Applicant: ENERGY PASS INCORPORATION, Hsinchu City (TW)

(72) Inventors: Chia-Hsieh Wu, Changhua County (TW); Ying-Che Lo, Tainan City (TW)

(73) Assignee: ENERGY PASS INCORPORATION, Hsinchu City (TW)

(21) Appl. No.: 13/654,423

(22) Filed: Oct. 18, 2012

(51) Int. Cl. G06F 19/00

(52) U.S. Cl. 702/63; 702/89

(57) ABSTRACT

A method for calculating electrical charge/discharge quantity for a battery unit includes: utilizing an oscillator for generating a clock signal; providing a storage unit for storing a calibration parameter that is used for adjusting or calibrating a time interval of electrical charge/discharge calculation; determining when to generate an interrupt signal to a controller according to the clock signal and the calibration parameter; and measuring a current associated with the battery unit and calculating the electrical charge/discharge quantity for the battery unit when the interrupt signal is generated.

### BACKGROUND OF THE INVENTION

1. Field of the Invention

The invention relates to an electrical charge/discharge calculation scheme, and more particularly to an apparatus and method for calculating quantity of electrical charge or quantity of electrical discharge for a battery unit according to a calibration parameter that is used for adjusting/calibrating a time interval of electrical charge calculation.

2. Description of the Prior Art

A conventional scheme employed for calculating electrical charge quantity or electrical discharge quantity for a battery unit is performed based on a fixed integral time interval. In practice, the fixed integral time interval is indicated by a group of consecutive clock cycles having a fixed cycle number, where the clock cycles are carried by a clock signal generated from an oscillator. Ideally, calculating electrical charge/discharge quantity based on the clock cycles having a fixed cycle number will obtain a precise calculation result; however, some variations may be introduced into the oscillator, which result in frequency shifts in the clock cycles. As a result, the clock cycles having a fixed cycle number cannot precisely indicate the integral time interval. Calculating electrical charge/discharge quantity based on clock cycles having a fixed cycle number actually may result in calculation errors.

### SUMMARY OF THE INVENTION

Therefore, one of the objectives of the present invention is to provide an apparatus and method for calculating an electrical charge quantity or electrical discharge quantity for a battery unit according to a calibration parameter used for adjusting/calibrating a time interval of electrical charge/discharge calculation, in order to solve the above-mentioned problems.

According to an embodiment of the present invention, a method for calculating electrical charge/discharge quantity for a battery unit is disclosed. The method comprises: utilizing an oscillator for generating a clock signal; providing a storage unit for storing a calibration parameter that is used for adjusting or calibrating a time interval of electrical charge/discharge calculation; determining when to generate an interrupt signal to a controller according to the clock signal and the calibration parameter; and measuring a current for the battery unit and calculating the electrical charge/discharge quantity for the battery unit when the interrupt signal is generated.

According to the embodiment of the present invention, an apparatus for calculating electrical charge/discharge quantity for a battery unit is disclosed. The apparatus comprises an oscillator, a storage unit, a timer, and a controller. The oscillator is utilized for generating a clock signal. The storage unit is utilized for storing a calibration parameter that is used for adjusting or calibrating a time interval of electrical charge/discharge calculation. The timer is coupled to the oscillator and the storage element and utilized for determining when to generate an interrupt signal to the controller according to the clock signal and the calibration parameter. The controller is coupled to the timer and utilized for measuring a current for the battery unit and calculating the electrical charge/discharge quantity for the battery unit when the interrupt signal is generated.

According to another embodiment of the present invention, a method for calibrating an integral time interval actually used by coulometry integration is disclosed. The method comprises: utilizing an oscillator for generating a clock signal; providing a storage unit for storing a calibration parameter that is used for adjusting or calibrating the integral time interval; and replacing a fixed integral time interval by using a time interval represented by the calibration parameter, to calibrate the integral time interval actually used.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an apparatus for calculating electrical charge quantity for a battery unit according to a first embodiment of the present invention.

FIG. 2 is a diagram illustrating a better effect that is achieved by the apparatus shown in FIG. 1 for using the calibration parameter to adjust a clock cycle number.

FIG. 3 is a diagram of an apparatus for calculating electrical charge quantity for the battery unit according to a second embodiment of the present invention.

FIG. 4 is a diagram illustrating a flowchart of the operation for generating the calibration parameter and using the calibration parameter to adjust the time interval and detect/measure the current associated with the battery unit at correct timings.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electric connection. Accordingly, if one device is coupled to another device, that connection may be through a direct electric connection, or through an indirect electric connection via other devices and connections.

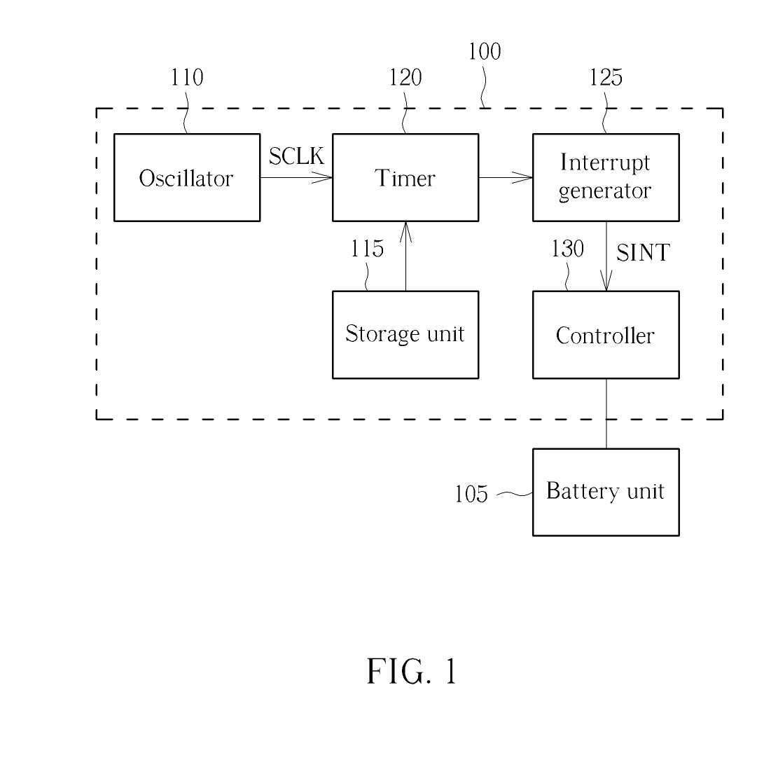

Please refer to FIG. 1, which is a block diagram of an apparatus 100 for calculating electrical charge quantity for a battery unit 105 according to a first embodiment of the present invention. The apparatus 100 is used to calculate or estimate the electrical charge quantity for the battery unit 105. The apparatus 100 employs coulometry integration to calculate electrical charge for the battery unit 105 during a predetermined integral time interval for estimating the electrical charge quantity for the battery unit 105. The employed coulometry integration is performed by the apparatus 100 according to the following equation: Q=I×Δt, wherein parameters Q, I, and Δt indicate the calculated electrical charge, the current associated with the battery unit 105, and the predetermined integral time interval, respectively. Accordingly, the calculated electrical charge quantity ‘Q’ depends on the current ‘I’ and the predetermined integral time interval ‘Δt’. The employed coulometry integration can be applied to process the current ‘I’ which may include some variations during the predetermined integral time interval ‘Δt’ since an integration such as coulometry integration can be regarded as an operation of accumulating the current during a predetermined integral time interval. In practice, the predetermined integral time interval Δt is represented by a group of consecutive clock cycles such as one thousand consecutive clock cycles. The coulometry integration can be performed and completed each time the end of these consecutive clock cycles occurs. In other words, the result of coulometry integration also depends on the number of these consecutive clock cycles. In this embodiment, for increasing the precision of a calculation result of the coulometry integration, the apparatus 100 is arranged to appropriately adjust or calibrate the number of consecutive clock cycles such that the predetermined integral time interval can be represented by the adjusted/calibrated number of consecutive clock cycles correctly.

As shown in FIG. 1, the apparatus 100 comprises an oscillator 110, a storage unit 115, a timer 120, an interrupt generator 125, and a controller 130. The oscillator 110 is used to generate an oscillation signal for generating a clock signal SCLK which is outputted to the timer 120. The storage unit 115 is used for storing the above-mentioned calibration parameter which is also outputted to the timer 120. In this embodiment, the clock signal SCLK includes repetitive clock cycles. Since the clock signal SCLK is generated based on the oscillator 110 with a specific oscillation frequency, the predetermined integral time interval described above can be equally indicated by a group of repetitive and consecutive clock cycles having a specific cycle number. For example, if the predetermined integral time interval is equal to one second, then the predetermined integral time interval can be indicated by one thousand consecutive clock cycles of a clock signal with a frequency 1 KHz. Please note that this example is merely used for illustrative purposes and is not intended to be a limitation of the present invention. Accordingly, in this embodiment, the apparatus 100 employs a group of consecutive clock cycles of the clock signal SCLK to preliminarily indicate the predetermined integral time interval, and uses the calibration parameter to adjust/calibrate the cycle number of the consecutive clock cycles for calibrating an actual integral time interval to the predetermined integral time interval.

In detail, the timer 120 receives the clock signal SCLK and the calibration parameter, and is arranged to determine when to trigger/generate an interrupt event to the interrupt generator 125 in accordance with the clock signal SCLK and the calibration parameter. In this embodiment, the timer 120 is arranged to count a number of clock cycles of the clock signal SCLK upwards from zero once the timer 120 receives the clock signal SCLK. The timer 120 does not stop counting until the number of clock cycles counted by the timer 120 matches the calibration parameter. When the counted number matches the calibration parameter, this indicates that the predetermined integral time interval ends, and the timer 120 is arranged to trigger an interrupt event to the following-stage circuit so as to complete the coulometry integration calculation. The calibration parameter indicates an actual cycle number corresponding to the predetermined integral time interval wherein the actual cycle number can be configured to be dependent upon the frequency of the clock signal SCLK. This is because using a fixed cycle number to indicate the predetermined integral time interval will introduce some calculation errors, because the total number of clock cycles of the clock signal SCLK during the predetermined integral time interval may change when frequency variations/shifts are introduced to the clock signal SCLK. Thus, the flexible calibration parameter is used by the apparatus 100 to adjust or modify the fixed cycle number, in order to obtain a precise result regardless of a frequency shift of the clock signal SCLK. Equivalently, the fixed cycle number is replaced with the flexible calibration parameter that indicates a precise clock cycle number.

When receiving the interrupt event triggered by the timer 120, the interrupt generator 125 is arranged to generate an interrupt signal SINT to the controller 130. When receiving the interrupt signal SINT from the interrupt generator 125, the controller 130 is arranged to complete the detection or measurement of the current for the battery unit 105. As a result, by using the calibration parameter for adjusting the fixed cycle number, the adjusted cycle number precisely corresponds to the predetermined integral time interval, and the operation of accumulating the current detected/measured (i.e. the coulometry integration calculation) each time can be performed correctly. A calculation result of the electrical charge quantity will become more precise.

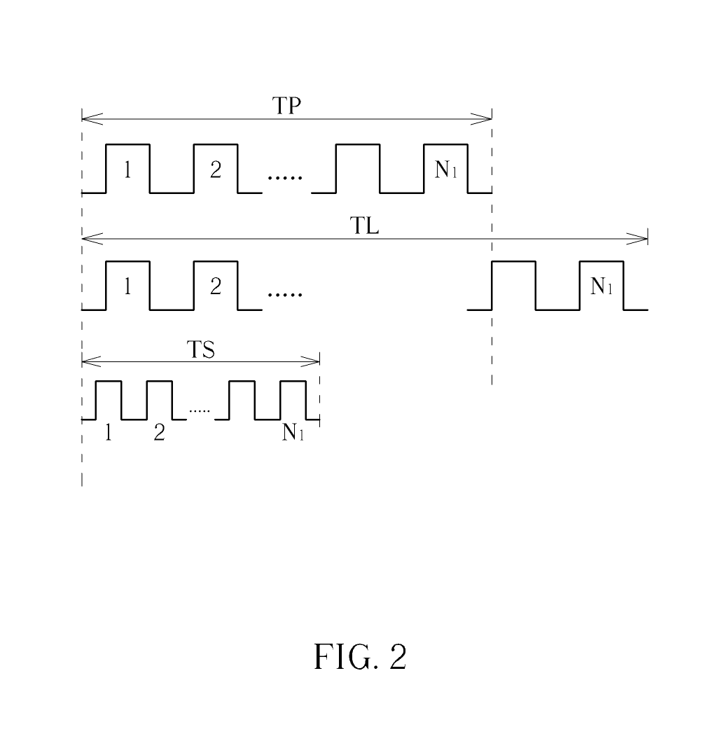

Please refer to FIG. 2, which is a diagram illustrating a better effect that is achieved by the apparatus 100 shown in FIG. 1 using the calibration parameter to adjust a clock cycle number. As shown in FIG. 2, TP indicates the predetermined integral time interval which can be correctly represented by a fixed number N1 of clock cycles of the clock signal SCLK when the frequency of the clock signal SCLK is precisely located at a fixed frequency. For example, the fixed number N1 is equal to one thousand, and the fixed frequency is 1 KHz. In practice, however, the frequency of the clock signal SCLK may be slightly shifted due to some conditions such as process variations, so an integral time interval (which is still represented by the fixed number N1) may become longer or shorter than the predetermined integral time interval. As shown in FIG. 2, TL indicates a longer integral time interval that is represented by clock cycles having the fixed number N1 under a condition that the frequency of the clock signal SCLK is slightly shifted and becomes lower. TS indicates a shorter integral time interval represented by clock cycles having the fixed number N1 under a condition that the frequency of the clock signal SCLK is slightly shifted and becomes higher. In these conditions, performing the coulometry integration directly based on the longer integral time interval TL or shorter integral time interval TS will introduce some calculation errors. Accordingly, the apparatus 100 is arranged to employ the calibration parameter to adjust or calibrate the fixed number N1. The calibration parameter is configured to be dependent upon the actual frequency of the clock signal SCLK. For instance, the calibration parameter is configured to be greater than the fixed number N1 if the actual frequency of the clock signal SCLK becomes higher. In another case, the calibration parameter is configured to be smaller than the fixed number N1 if the actual frequency of the clock signal SCLK becomes lower. For example, the calibration parameter is configured as a number slightly smaller than one thousand (i.e. the fixed number N1), e.g. 990. The calibration parameter can also be configured as a number slightly greater than one thousand (i.e. the fixed number N1), e.g. 1110. In this way, the timer 120 is arranged to count the number of cycles of the clock signal SCLK upwards from zero, and can correctly complete number counting at a precise timing. The controller 130 can then detect or measure the current for the battery unit 105 at the precise timing, and the apparatus 100 can correctly calculate the electrical charge quantity for the battery unit 105.

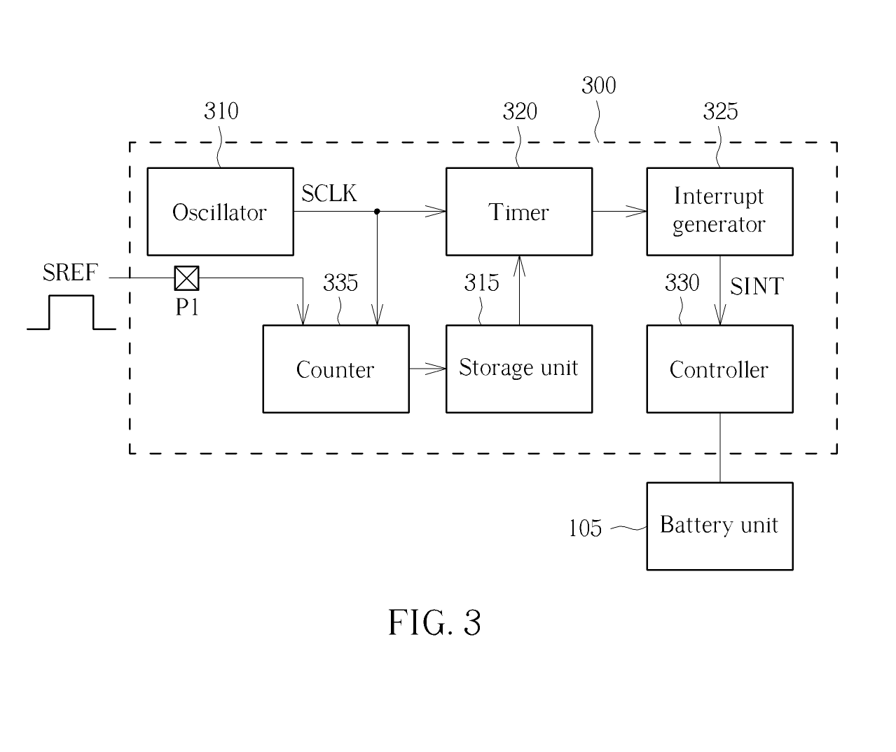

The calibration parameter can be configured in the storage unit before the apparatus 100 leaves the factory or can be downloaded to the storage unit from any external circuit when the apparatus 100 is being used. Please refer to FIG. 3, which is a diagram of an apparatus 300 for calculating electrical charge quantity for the battery unit 105 according to a second embodiment of the present invention. The apparatus 300 comprises an oscillator 310, a storage unit 315, a timer 320, an interrupt generator 325, a controller 330, and a counter 335. The respective operation and function of the oscillator 310, storage unit 315, timer 320, interrupt generator 325, and the controller 330 are identical to those of the oscillator 110, storage unit 115, timer 120, interrupt generator 125, and the controller 130; further description is not detailed for brevity. The counter 335 is coupled to the timer 320 and the storage unit 315 and is utilized for receiving a reference pulse signal SREF which is inputted to the apparatus 300 via the port P1. The reference pulse signal SREF is an accurate pulse signal with a pulse width substantially equal to the predetermined integral time interval. When the assertion of the reference pulse signal SREF occurs, the counter 335 starts to count the clock cycles of the clock signal SCLK. Once the de-assertion of the reference pulse signal SREF occurs, the counter 335 counts the number of clock cycles of the clock signal SCLK, records the counted number to the storage unit 315 for setting the calibration number as the recorded number, and completes the number counting. Since the reference clock signal SREF is an accurate and precise pulse signal, the predetermined integral time interval can be correctly and precisely represented by the pulse width of the signal SREF. The cycle number of the clock signal SCLK recorded by the counter 335 can be used to appropriately represent an actual total number of clock cycles during the predetermined integral time interval. Therefore, the recorded cycle number is used as the calibration parameter. The operation of determining the calibration parameter can be performed every time when the apparatus 300 reboots. In addition, the reference pulse signal SREF can be provided to the apparatus 300 when the apparatus 300 is still in the factory, and therefore may not need to be provided again since the calibration number has been generated and stored in the storage unit 315. In other embodiments, the reference pulse signal SREF is not provided to the apparatus 300 after the apparatus 300 leaves the factory. All these modifications obey the spirit of the present invention.

It should be noted that the assertion of a signal denotes its active state and the de-assertion of the signal denotes its inactive state. In the above-mentioned embodiment, the assertion of the reference pulse signal SREF occurring indicates its rising edge occurring, and the de-assertion of the reference pulse signal SREF occurring indicates its falling edge occurring. However, this is not indented to be a limitation of the present invention. In another embodiment, a different reference pulse signal (not shown), which includes a reverse waveform of the reference pulse signal SREF, can be used to replace the reference pulse signal SREF. That is, in the embodiment, when the falling edge of the different reference pulse signal occurs, the counter 335 starts to count the clock cycles of the clock signal SCLK. Once the rising edge of the different reference pulse signal occurs, the counter 335 counts the number of clock cycles of the clock signal SCLK, records the counted number to the storage unit 315 for setting the calibration number as the recorded number, and completes the number counting.

Furthermore, in other embodiments, the apparatus 100 as shown in FIG. 1 can be employed for calculating electrical discharge quantity for the battery unit 105. In the embodiments, the coulometry integration can be also employed by the apparatus 100 to calculate electrical discharge quantity for the battery unit 105 during a predetermined integral time interval. The operations and functions of the circuit elements included within the apparatus 100 are described above, and are not detailed here for brevity.

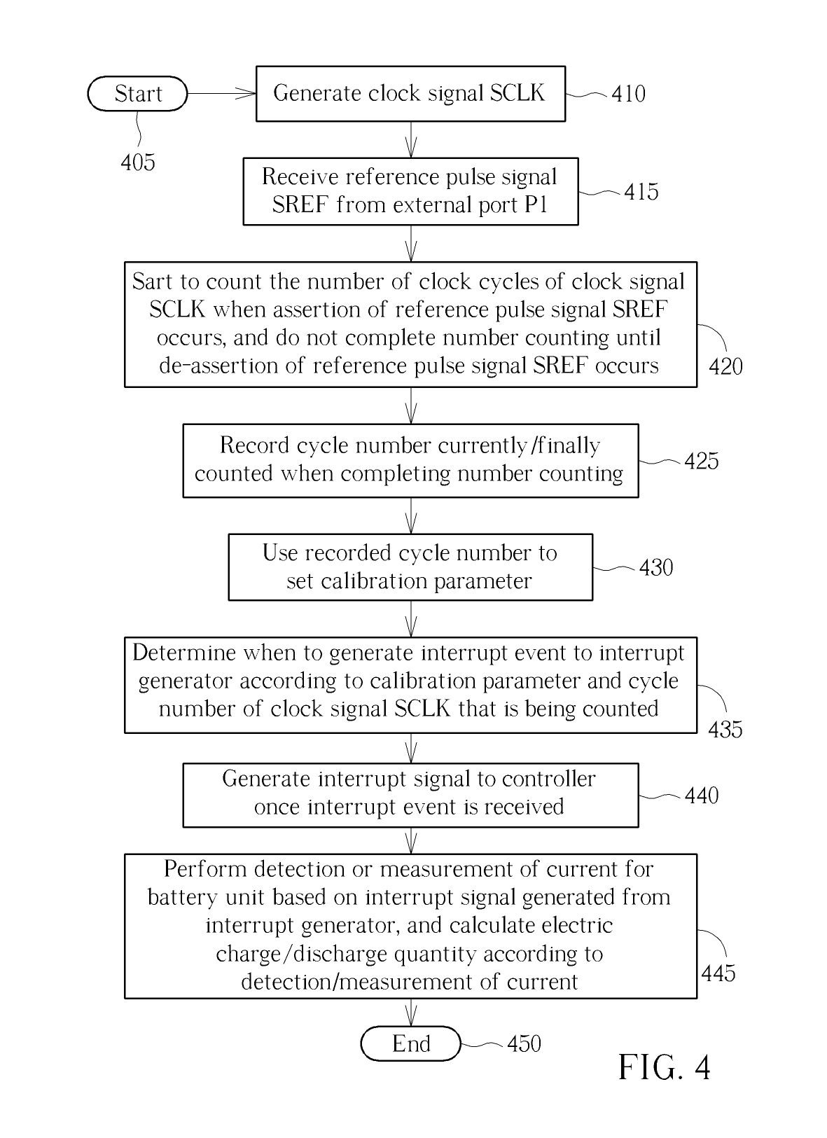

Please refer to FIG. 4, which is a diagram illustrating a flowchart of the operation for generating the calibration parameter and using the calibration parameter to adjust the time interval and detect/measure the current for the battery unit 105 at correct timings. Provided that substantially the same result is achieved, the steps of the flowchart shown in FIG. 4 need not be in the exact order shown and need not be contiguous; that is, other steps can be intermediate. The steps of FIG. 4 are detailed in the following:

Step 405: Start;

Step 410: The oscillator 310 generates the clock signal SCLK, and the clock signal SCLK is transmitted to the counter 335 and timer 320;

Step 415: The apparatus 300 receives the reference pulse signal SREF from the external port P1, and the reference pulse signal SREF is transmitted to the counter 335;

Step 420: The counter 335 starts to count the number of clock cycles of the clock signal SCLK when the assertion of the reference pulse signal SREF occurs, and does not complete the number counting until the de-assertion of the reference pulse signal SREF occurs;

Step 425: When completing the number counting, the counter 335 records the cycle number currently/finally counted and outputs the cycle number to the storage unit 315;

Step 430: The recorded cycle number is used to set the calibration parameter and stored in the storage unit 315;

Step 435: The timer 320 determines when to generate an interrupt event to the interrupt generator 325 according to the calibration parameter stored in the storage unit and the cycle number of the clock signal SCLK that is being counted by the timer 320;

Step 440: The interrupt generator 325 generates an interrupt signal to the controller 330 once the interrupt event is received;

Step 445: The controller 330 performs detection or measurement of the current for the battery unit 105 based on the interrupt signal generated from the interrupt generator 325, and calculates the electrical charge quantity according to the detection/measurement of the current;

Step 450: End.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for calculating electrical charge quantity or electrical discharge quantity for a battery unit, comprising:
utilizing an oscillator for generating a clock signal;
providing a storage unit for storing a calibration parameter that is used for adjusting or calibrating a time interval of electrical charge/discharge calculation;
determining when to generate an interrupt signal to a controller according to the clock signal and the calibration parameter; and
measuring a current associated with the battery unit and calculating the electrical charge quantity or the electrical charge quantity for the battery unit when the interrupt signal is generated.

2. The method of claim 1, wherein the step of determining when to generate the interrupt signal comprises:
counting a number of clock cycles of the clock signal upwards from zero; and
determining to generate the interrupt signal when the counted number matches the calibration parameter.

3. The method of claim 1, further comprising:
providing a reference pulse signal;
counting a number of clock cycles of the clock signal upwards from zero during a pulse width of the reference pulse signal;
recording the number finally counted when an end of the pulse width occurs; and
using the recorded number as the calibration parameter.

4. The method of claim 1, wherein the time interval is an integral time interval actually employed by coulometry integration.

5. An apparatus for calculating electrical charge quantity or electrical charge quantity for a battery unit, comprising:
an oscillator for generating a clock signal;
a storage unit for storing a calibration parameter that is used for adjusting or calibrating a time interval of electrical charge/discharge calculation;
a timer, coupled to the oscillator and the storage element, for determining when to generate an interrupt signal according to the clock signal and the calibration parameter; and
a controller, coupled to the timer, for receiving the interrupt signal, measuring a current associated with the battery unit, and calculating the electrical charge quantity or the electrical charge quantity for the battery unit when the interrupt signal is received.

6. The apparatus of claim 5, wherein the timer is arranged to count a number of clock cycles of the clock signal upwards from zero and determine to generate the interrupt signal when the counted number matches the calibration parameter.

7. The apparatus of claim 5, further comprising:
a counter, coupled to the oscillator and the timer, for receiving a reference pulse signal, counting a number of clock cycles of the clock signal upwards from zero during a pulse width of the reference pulse signal, and recording the number finally counted when an end of the pulse width occurs;
wherein the recorded number is transmitted to and stored in the storage unit and used as the calibration parameter.

8. The apparatus of claim 5, wherein the time interval is an integral time interval actually employed by coulometry integration.

9. A method for calibrating an integral time interval actually used by coulometry integration, comprising:
utilizing an oscillator for generating a clock signal;
providing a storage unit for storing a calibration parameter that is used for adjusting or calibrating the integral time interval; and
replacing a fixed integral time interval by using a time interval represented by the calibration parameter, to calibrate the integral time interval actually used.
